(19) United States
(12) Patent Application Publication
(10) Pub. No.: US 2014/0042284 A1
(43) Pub. Date: Feb. 13, 2014

(54) APPARATUS FOR DISPLAY OF STUFFED ANIMALS

(71) Applicant: Whitney Bagley, Dallas, TX (US)

(72) Inventor: Whitney Bagley, Dallas, TX (US)

(21) Appl. No.: 13/569,170

(22) Filed: Aug. 7, 2012

(51) Int. Cl. F16M 13/02

(52) U.S. Cl. 248/315; 248/309.1

(57) ABSTRACT

The present invention is directed to an apparatus for display of stuffed animal comprising a base frame, the base frame having a front surface and a rear surface and a coupler operable to contact the outer surface of and bear the load of the stuffed animal. In one embodiment, the coupler comprises a curvilinear, flexible arm secured to the base frame and manipulable past its anchor point. In a second embodiment, the coupling comprises a band secured to the base frame at its first and second ends, presenting a perimeter bounded by the band and base frame. The apparatus optionally further comprises a mount.

### BACKGROUND

1. Field of the Invention

The present invention relates to a stuffed animal display apparatus, and more particularly, to a mountable stuffed animal display apparatus.

2. Description of the Related Art

Stuffed animals are popular collectible items throughout the world, being popular with children and adults. Some types and brands of stuffed animals have become considerably expensive and sought after. In many homes, stuffed animals are displayed in the manner of fine china or other types of expensive collectibles.

Children can have a particular affinity for stuffed animals. They frequently have a large collection of them with an affinity for any particular stuffed animal in the collection varying over time. A child may bond with a particular stuffed animal for a period of time, with that stuffed animal being a comfort object for the child in different situations, such as bedtime, discipline, or more unusual or unique situations.

There are times when it may not be practical or desired to physically hold the stuffed animal. Still, the visual presence of the stuffed animal can provide comfort or joy to its owner. Because of this it is desirable to have the option to mount the stuffed animal at a vantage point where it can readily be seen without a mechanical or detracting appearance. However, stuffed animals are available in a wide variety of sizes, weights, shapes, and configurations.

There are devices for storing stuffed animals. There are devices for display of stuffed animals, however, they are often large and unwieldy. Additionally, those devices can become the focus instead of the stuffed animal itself. The prior devices tend to force the user to place the stuffed animal to fit into a shaped aperture, limiting the display positions and portions of the stuffed animal and forcing the stuffed animal to conform to the shape of the aperture instead of generally conforming to the unaltered shape of stuffed animal. The art has yet to create an apparatus which can be mounted and hold a stuffed animal for aesthetically pleasing display at a desired vantage point, so that it is displayed as intended. For the above reasons, it would be advantageous for the art to have a mountable apparatus capable of holding a stuffed animal

### SUMMARY

The present invention is directed to an apparatus for display of stuffed animal comprising a base frame, the base frame being generally planar and having a front surface and a rear surface, and a coupler operable to contact the outer surface of the stuffed animal and bear the load of the stuffed animal.

These and other features, aspects, and advantages of the invention will become better understood with reference to the following description, and accompanying drawings.

### BRIEF DESCRIPTION OF THE DRAWINGS

FIG. 1 depicts a side perspective view of an embodiment of the invention; and

FIG. 2 depicts a side perspective view of an alternate embodiment of the invention;

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

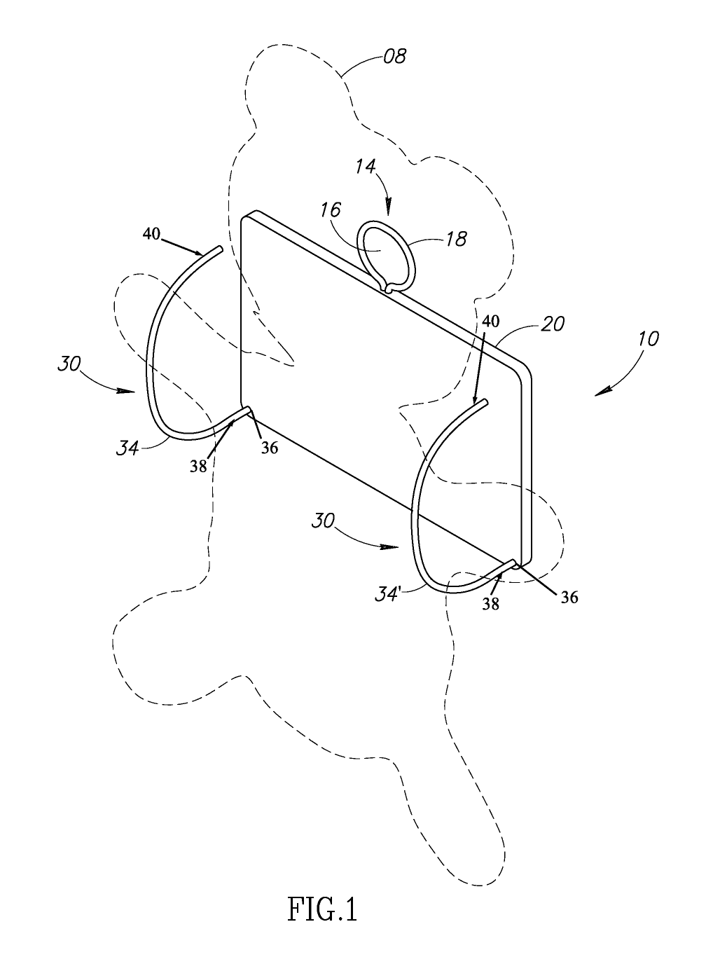

The present invention is directed to an apparatus which facilitates display of a stuffed animal. Stuffed animals, as defined in this application, include stuffed toys simulating dogs, cats, or other types of creatures or characters. Referring to FIG. 1, the apparatus includes a base frame 20, a pair of couplers 30, and a mount 14.

The base frame 20 is a generally planar member operable to contact the outer surface of a portion of the stuffed animal 08. The depicted base frame 20 is a rectangular member. However the base frame 20 may take other shapes. In an alternate configuration, the base frame 20 is shaped as a wire frame, where it presents a perimeter surrounding a hollow interior, providing a minimal area as a contact surface to the stuffed animal 08. The base frame 20 has a front face 22, a rear face 24, an upper region 23, and a lower region 25.

The stuffed animal display apparatus 10 includes at least one coupler 30. The coupler 30 is operable to contact the outer surface of and bear the load of the stuffed animal 08, while minimally disturbing the outer surface of the stuffed animal 08. The coupler 30 enables the stuffed animal 08 to be removably attached to the stuffed animal display apparatus 10. The coupler 30 is secured to the base frame 20 and extends outwardly from the front face 22 of the base frame 20.

Still referring to FIG. 1, a first embodiment having a pair of couplers 30 34 is shown. Each coupler 30 34 of this embodiment is a curvilinear arm 34 secured to the base frame 20. Each arm 34 is a semi-rigid length of material having a proximal end 38 and a distal end 40. The depicted arm 34 is preferably biased towards the depicted curvilinear configuration. Furthermore, the arm 34 is flexible substantially along its entire length. The flexibility can be enabled via composition or mechanical structure. Accordingly, the arm 34 may be composed of metals, plastics, composites, or other suitable material. Alternatively, the arm 34 may be composed of short articulated sections. The proximal end 38 of the arm 34 is secured to the base frame 20 at an anchor point 36, preferably to the lower region 25 of front face 22. The arm 34 extends outwardly from the base frame 20 and its flexibility facilitates lateral and longitudinal manipulation along the majority points of its length. The manipulation effectively enables three degrees of freedom of the entire arm 34 and enables the entire arm 34 to be shaped into a wide variety of configurations. Although it is to be understood that an additional arm 34 is not required, the embodiment of FIG. 1 includes a second arm 34′ secured to the opposing side of the base frame 20. The second arm 34′ is capable of independent manipulable movement with respect to the other arm 34.

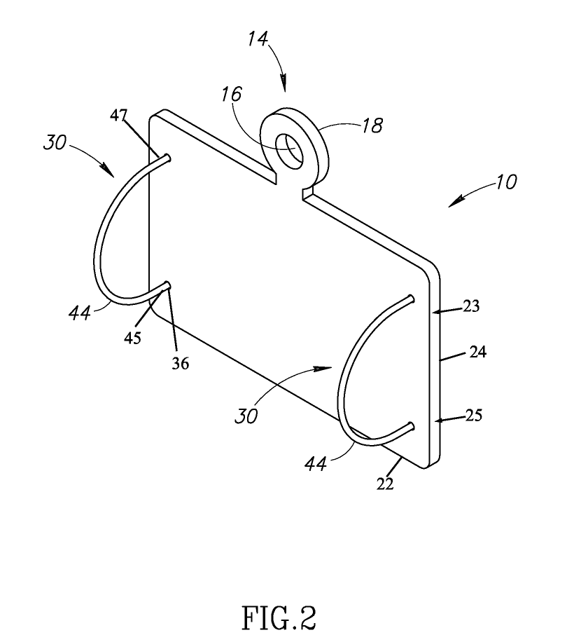

FIG. 2 illustrates an alternate embodiment. As shown, this embodiment includes a pair of couplers 30 44. Each coupler 30 44 of this embodiment is a band 44 secured to the base frame 20. The band 44 is a length of material having a first end 45 and a second end 48 and is preferably elastic. A first end 45 of the band 44 is secured to the base frame 20, preferably in the upper region 23. A second end 47 of the band 44 is secured to the base frame 20, preferably in the lower region 25 of the base frame 20 and distal to the first end 45. A perimeter is defined by the combination of the band 44 and the base frame 20 through which a portion of the stuffed animal 08 may be slidably placed. The band 44 may be composed of rubber compositions or other suitable materials. The length of the band 44 is configured to contact the outer surface of a range of stuffed animals 08. Additionally, the modulus and elongation of the elastic band 44 are configured to bear the load of and minimally disturb the outer surface of the stuffed animal 08.

The stuffed animal holder 10 also includes a mount 14 to aid securing the apparatus 10 to a wall, ceiling, or other structure. The illustrated mount includes a rim 18 attached to the base frame 20, preferably to the upper region 23. The rim 18 surrounds a hole 16 enabling a user to place a mechanical fastener therethrough.

In use the stuffed animal holder 10 is placed adjacent to the mounting surface such the the plane presented by the base frame 20 contacts the mounting surface. A mechanical fastener such as a tack is placed through the rim 18 to secure the apparatus 10 to the mounting surface. The stuffed animal 08 is placed engaged to the contact surface of the base frame 20. The coupler 30 is manipulated to contact and secure the stuffed animal 08.

Insofar as the description above and the accompanying drawings disclose any additional subject matter, the inventions are not dedicated to the public and the right to file one or more applications to claim such additional inventions is reserved.

What is claimed is:

1. An apparatus for display of stuffed animal comprising:
a base frame, said base frame being generally planar and having a front surface and a rear surface; and
a coupler, said coupler comprises a curvilinear arm having a proximal end and a distal end, said arm secured to said base frame at said proximal end and unsecured at said distal end, said curvilinear arm manipulable laterally and longitudinally past its proximal end, and said curvilinear arm's length and composition selected to enable controlled user deformation of said arm along said length in order to bear load and minimally disturb the surface of said stuffed animal.

2. The apparatus of claim 1 wherein said arm is comprised of articulated segments.

3. The apparatus of claim 1 further comprising a second curvilinear arm, distal to said arm, having a proximal end and a distal end, said second curvilinear arm secured to said base frame at said proximal end and unsecured at said distal end, said second arm manipulable laterally and longitudinally past its proximal end, and said second curvilinear arm's length and composition selected to enable controlled user deformation of said second arm along said length in order to bear load and minimally disturb the surface of said stuffed animal.

4. An apparatus for display of stuffed animal comprising:
a base frame, said base frame being generally planar and having a front surface and a rear surface; and
a coupler comprising a first band, composed of elastic material, having a first end and a second end, said first end of said first band anchored to said base frame at a first anchor point, said second end of said first band anchored to said base frame at a second anchor point distal to said first anchor point;
the length, elasticity, and modulus of said first band is selected to minimally disturb the surface of a stuffed animal.

5. (canceled)

6. (canceled)

7. The apparatus of claim 4 further comprising a second band, composed of elastic material, having a first end and a second end, said first end of said band anchored to said base frame at a first anchor point distal to said anchor point of said first band, said second end of said second band anchored to said base frame at a second anchor point distal to said first anchor point of said second band;
the length, elasticity, and modulus of said second band is selected to minimally disturb the surface of a stuffed animal.

8. (canceled)

9. (canceled)

10. The apparatus of claim 1 further comprising a mount.

11. (canceled)

12. (canceled)

13. (canceled)

14. The apparatus of claim 1 wherein said base frame comprises a wire frame, said wire frame presenting a perimeter surrounding a hollow interior.

15. The apparatus of claim 4 wherein said base frame comprises a wire frame, said wire frame presenting a perimeter surrounding a hollow interior.

16. The apparatus of claim 4 further comprising a mount.
